(19) United States
(12) Patent Application Publication
(10) Pub. No.: US 2018/0166045 A1
(43) Pub. Date: Jun. 14, 2018

(54) EFFICIENT OCCLUSION DETECTION IN DISPLAY COMPOSITOR

(71) Applicant: QUALCOMM Incorporated, San Diego, CA (US)

(72) Inventors: Saurabh Shah, San Diego, CA (US); Nagamalleswararao Ganji, San Diego, CA (US); Naomi Luis, San Diego, CA (US); Andrew Yelder, San Diego, CA (US)

(21) Appl. No.: 15/377,712

(22) Filed: Dec. 13, 2016

(51) Int. Cl. G09G 5/377; G06T 7/90

(52) U.S. Cl. CPC G09G 5/377; G06T 2210/62; G06T 2207/20212; G06T 7/90

(57) ABSTRACT

Techniques are described for generating image content for display. A host processor may read opacity information generated by processing circuitry for one or more blocks of pixels of a first layer of a plurality of layers. The host processor may determine an inner rectangular portion of the first layer that is substantially opaque based on the read opacity information, and instruct a display processor to not retrieve, for use in composing the plurality layer, an area of a second layer of the plurality of layers that is occluded by the inner rectangular portion of the first layer. The display processor may compose the plurality of layers to generate an image frame for display.

### TECHNICAL FIELD

This disclosure relates to displaying image content, and more particularly, to image content to be displayed.

### BACKGROUND

A graphics processing unit (GPU), a video processor, or a camera processor generates image content, referred to as a surface/window/layer content, and stores the image content in a layer buffer. A display processor retrieves the image content from the layer buffer, composes the image content into a frame, and outputs the composed frame for display. The generated image content includes a plurality of layers (e.g., distinct portions of the frame and the display processor composes the layers together for display.

### SUMMARY

In general, the disclosure describes techniques for determining image content of a layer that is opaque, and avoiding the retrieval of layers below (e.g., behind, covered by, or occluded by) the layer that is opaque. Processing circuitry may assign an opacity value to each block of image content that the processing circuitry generates. The processing circuitry assigns a first opacity value if all pixels in the block are opaque, and a second opacity value if any one pixel in the block is not opaque. A display compositor may evaluate opacity values starting from corners of a rectangular area until two blocks are identified that are fully opaque, where all other blocks in the row and/or column of these blocks are opaque. The display compositor may then evaluate opacity values of blocks that reside within a rectangular area that covers the two identified blocks, and if all blocks are opaque (e.g., all pixels in each of the blocks is opaque), the display compositor causes the display processor to avoid retrieving layers of image content that are occluded (e.g., to cause the display processor to retrieve an entire layer except for a certain portion of that layer).

In one example, the disclosure describes a device for generating image content for display, the device comprising a display processor configured to compose a plurality of layers of image content to generate an image frame for display, processing circuitry configured to generate opacity information for one or more blocks of pixels of a first layer of the plurality of layers, wherein the opacity information indicates whether all pixels in a block are opaque or at least one pixel in the block is not opaque, and a host processor. The host processor is configured to read the opacity information for one or more blocks of pixels of the first layer, determine an inner rectangular portion of the first layer that is substantially opaque based on the read opacity information, and instruct the display processor to not retrieve, for use in composing the plurality of layers, an area of a second layer of the plurality of layers that is occluded by the inner rectangular portion of the first layer.

In one example, the disclosure describes a method for generating image content for display, the method comprising method for generating image content for display, the method comprising generating, with processing circuitry, opacity information for one or more blocks of pixels of a first layer of the plurality of layers, wherein the opacity information indicates whether all pixels in a block are opaque or at least one pixel in the block is not opaque, reading, with a host processor, the opacity information for blocks of a first layer of a plurality of layers of image content, determining, with the host processor, an inner rectangular portion of the first layer that is substantially opaque based on the read opacity information, instructing, with the host processor, a display processor to not retrieve, for use in composing the plurality of layers, an area of a second layer of the plurality of layers that is occluded by the inner rectangular portion of the first layer, and composing, with the display processor, the plurality of layers to generate an image frame for display.

In one example, the disclosure describes a device for generating image content for display, the device comprising means for generating opacity information for one or more blocks of pixels of a first layer of the plurality of layers, wherein the opacity information indicates whether all pixels in a block are opaque or at least one pixel in the block is not opaque, means for reading the opacity information for blocks of a first layer of a plurality of layers of image content, means for determining an inner rectangular portion of the first layer that is substantially opaque based on the read opacity information, means for instructing a display processor to not retrieve, for use in composing the plurality of layers, an area of a second layer of the plurality of layers that is occluded by the inner rectangular portion of the first layer, and means for composing the plurality of layers to generate an image frame for display.

In one example, the disclosure describes a computer-readable storage medium having instructions stored thereon that when executed cause one or more processors to generate opacity information for one or more blocks of pixels of a first layer of the plurality of layers, wherein the opacity information indicates whether all pixels in a block are opaque or at least one pixel in the block is not opaque, read the opacity information for blocks of a first layer of a plurality of layers of image content, determine an inner rectangular portion of the first layer that is substantially opaque based on the read opacity information, instruct a display processor to not retrieve, for use in composing the plurality of layers, an area of a second layer of the plurality of layers that is occluded by the inner rectangular portion of the first layer, and compose the plurality of layers to generate an image frame for display.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example device for image composition and display in accordance with one or more example techniques described in this disclosure.

FIG. 2 is a block diagram illustrating components of the device illustrated in FIG. 1 in greater detail.

FIG. 3 is a graphical diagram of an image to illustrate an example operation in accordance with this disclosure.

FIG. 4 is a flowchart illustrating an example technique image composition and display in accordance with this disclosure.

### DETAILED DESCRIPTION

Various applications executing on a processor, as well as operating system level operations, create image content for display. As an example, an application executing on the processor may generate image content for the current date and time, another application executing on the processor may generate image content for the background and/or edges of a display, another application executing on the processor may generate image content for indicating an audio volume level, and so forth. As additional examples, a video decoder may decode video data for display in at least a portion of an image frame. Other examples exist, and the techniques are generally related to various examples of where image content is generated for display.

Each of the generated image contents may be considered as a separate layer, and a system memory may include a layer buffer that stores each of the layers. For example, a graphics processing unit (GPU) may generate the image content for the wallpaper, time, volume, etc., and each of these may be layers stored in respective portions of a layer buffer. The processor may instruct a display processor to retrieve the layers from the layer buffer and compose the layers together to form the composed image (i.e., a composite image that combines the layers) that the display processor displays.

Certain layer types may include predominant opaque content with some translucent content, such as along the edge. As an example, a pop-up window tends to be opaque throughout except near borders where the content is translucent giving the border a shadowy edge. This shadowy edge gives the perception that the pop-up window is “popping up.”

A display compositor is a software driver that executes on a host processor and interfaces with the display processor that blends the layers together. The display compositor configures the display processor to retrieve layers from system memory and blend the layers together. One issue may be that the display compositor tends to be limited in being able to determine whether a layer occludes another layer. Therefore, the display compositor configures a display processor to retrieve portions of layers that are ultimately not viewable.

For example, for the display compositor to determine that some pixels in a pop-up window are translucent and others are not may require the display compositor to check pixel-by-pixel whether the pixel is translucent or opaque. Such pixel-by-pixel operation may be time consuming and require a lot of processing resources.

In the example techniques described in this disclosure, the GPU (and more generally any component that generates content for display) generates block-by-block opacity information for each layer. For example, assume that a block is 128×128 pixels, and the color of each pixel is defined by RGBA (red-green-blue-alpha, where alpha indicates opacity). In this example, for a block of 128×128 pixels, the GPU may store an opacity value of “1” if the alpha value for all pixels in the block indicates that all pixels are fully opaque, and an opacity value of “0” if the alpha value of at least one pixel in the block indicates that the pixel is not fully opaque. Having opacity at a block level allows the display compositor to determine for a group of pixels (e.g., 128×128 block of pixels) if all pixels are opaque rather than pixel-by-pixel.

The display compositor may use the block level opacity information to identify portions of layers that are fully opaque. As one example, for a layer, the display compositor may start from a top-left corner of the layer, and evaluate opacity values for blocks column-wise for a first column (e.g., left-most column) of the layer. If all blocks in that column are opaque, the display compositor may determine a left boundary for a portion of the layer that is fully opaque. If one block in the column is not opaque, the display compositor may proceed inward (e.g., rightward in this case) to the next column of blocks until the display compositor determines a left boundary for the portion of the layer that is fully opaque or reaches the right end of the layer.

The display compositor may perform similar operations of evaluating opacity values for blocks in a column starting from the right-most column of the layer, and evaluate opacity values of blocks column-wise and moving inward (e.g., leftward in this case) until the display compositor identifies a column having fully opaque blocks. The display compositor may identify this column as a right boundary for the portion of the layer that is fully opaque. The display compositor may repeat these operations starting from the top row of the layer and moving inwards (e.g., downwards in this case) until the display compositor identifies a row having fully opaque blocks, and identify this row as a top boundary for the portion of the layer that is fully opaque. Similarly, the display compositor may repeat these operations starting from the bottom-row of the layer and moving inwards (e.g., upwards in this case) until the display compositor identifies a row having fully opaque blocks, and identify this row as a bottom boundary for the portion of the layer that is fully opaque.

At the conclusion of these operations, the display compositor may have identified an inner rectangular portion (e.g., less than the entire layer) of the layer that is fully opaque. In some examples, the display compositor may evaluate each of the blocks in the inner rectangular portion to confirm that all blocks in the portion are opaque. For layers that are below the layer having this opaque rectangular portion, the display compositor may instruct a display processor to not retrieve portions of below layers that are overlapped by this inner rectangular portion. For example, the display processor may compose the plurality of layers to generate an image frame for display, and the display compositor may instruct the display processor to not retrieve, for use in composing the plurality of layers, portion of below layers that are overlapped by this inner rectangular portion.

The above was one example technique for determining an opaque portion of a layer. For the shadow effect, there may be some example efficiency gains that may be achieved. For example, for a layer, the display compositor may divide the layer into blocks, start from the top-left and bottom-right corners of the layer, and evaluate the opacity information block-by-block for each block until the display compositor determines a first block starting from the top-left corner that is fully opaque and a second block starting from the bottom-right corner that is fully opaque. The display compositor may evaluate blocks going diagonally inward or some other scanning technique.

The first and second blocks form respective corners of an inner rectangular portion (e.g., the top-left pixel of the first block forms the top-left corner of the inner rectangular portion and the bottom-right corner of the second block forms the bottom-right corner of the inner rectangular portion). There is a relatively high likelihood that the rest of the blocks in the inner rectangular portion are opaque (e.g., between the first and second blocks). For instance, in the pop-up window, the blocks of pixels along the border will have one pixel that is not opaque because these pixels form the shadowy effect with translucent pixels, but other than along the border the rest of the layer is completely opaque.

In some examples, the display compositor may determine that the entire inner rectangular portion is opaque after identifying the first and second blocks. In some examples, the display compositor may confirm that the entire inner rectangular portion is truly opaque by reading the opacity information block-by-block for the blocks in the inner rectangular portion.

In the above examples of determining the inner rectangular portion of a layer that is opaque, the display compositor may use the information of the inner rectangular portion to determine which portions of which layers the inner rectangular portion occludes. For example, the host processor may define where each of the layers is to be displayed on the display and the order of the layers (e.g., bottom-most to top-most layer). The display compositor may determine the location of where the inner rectangular portion of a layer is located on the display, and determine which layers are going to be located at the same location that the inner rectangular portion occludes.

In addition to configuring the display processor retrieve layers, one of the functionalities of the display compositor may be to instruct the display processor to specifically not retrieve some area of layer. For example, the display compositor may configure the display processor to retrieve an entire layer except for a certain portion of that layer.

In the example techniques described in this disclosure, the display compositor may instruct the display processor to not retrieve, for use in composing the plurality of layers, areas of layers that are occluded by the inner rectangular portion. For example, after the display compositor determines which portions of which layers will be occluded by the inner rectangular portion, the display compositor may instruct the display processor to not retrieve, for use in composing the plurality of layers, portions of layers that are occluded.

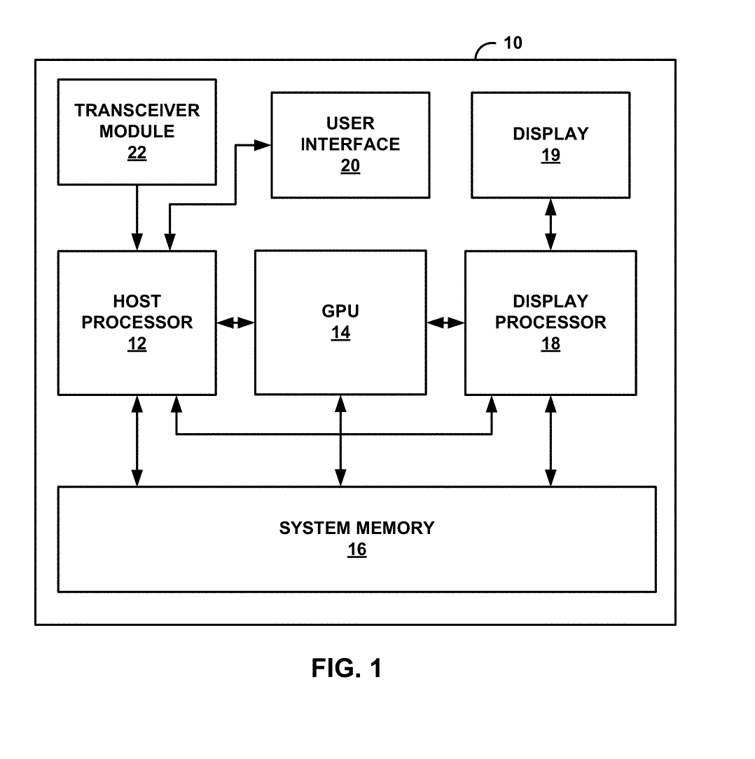

FIG. 1 is a block diagram illustrating an example device for image display in accordance with one or more example techniques described in this disclosure. FIG. 1 illustrates device 10, examples of which include, but are not limited to, video devices such as media players, set-top boxes, wireless handsets such as mobile telephones (e.g., so-called smartphones), personal digital assistants (PDAs), desktop computers, laptop computers, gaming consoles, video conferencing units, tablet computing devices, and the like.

In the example of FIG. 1, device 10 includes host host processor 12, graphics processing unit (GPU) 14, system memory 16, display processor 18, display 19, user interface 20, and transceiver module 22. In examples where device 10 is a mobile device, display processor 18 is a mobile display processor (MDP). In some examples, such as examples where device 10 is a mobile device, host host processor 12, GPU 14, and display processor 18 may be formed as an integrated circuit (IC). For example, the IC may be considered as a processing chip within a chip package, and may be a system-on-chip (SoC). In some examples, two of processors 12, GPU 14, and display processor 18 may be housed together in the same IC and the other in a different integrated circuit (i.e., different chip packages) or all three may be housed in different ICs or on the same IC. However, it may be possible that host host processor 12, GPU 14, and display processor 18 are all housed in different integrated circuits in examples where device 10 is a mobile device.

Examples of host host processor 12, GPU 14, and display processor 18 include, but are not limited to, one or more digital signal processors (DSPs), general purpose microprocessors, application specific integrated circuits (ASICs), field programmable logic arrays (FPGAs), or other equivalent integrated or discrete logic circuitry. Host host processor 12 may be the central processing unit (CPU) of device 10. In some examples, GPU 14 may be specialized hardware that includes integrated and/or discrete logic circuitry that provides GPU 14 with massive parallel processing capabilities suitable for graphics processing. In some instances. GPU 14 may also include general purpose processing capabilities, and may be referred to as a general purpose GPU (GPGPU) when implementing general purpose processing tasks (i.e., non-graphics related tasks). Display processor 18 may also be specialized integrated circuit hardware that is designed to retrieve image content from system memory 16, compose the image content into an image frame, and output the image frame to display 19. For example, display 19 may be configured to display the image frame.

Host host processor 12 may execute various types of applications. Examples of the applications include web browsers, e-mail applications, spreadsheets, video games, photo presentation or editing applications, video playback or editing applications, or other applications that generate viewable objects for display. System memory 16 may store instructions for execution of the one or more applications. The execution of an application on host host processor 12 causes host host processor 12 to produce graphics data for image content that is to be displayed. Host host processor 12 may transmit graphics data of the image content to GPU 14 for further processing based on and instructions or commands that host host processor 12 transmits to GPU 14.

Host host processor 12 may communicate with GPU 14 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, OpenGL, or OpenCL APIs, and may be extended to other types of APIs. Moreover, the techniques described in this disclosure are not required to function in accordance with an API, and host host processor 12 and GPU 14 may utilize any technique for communication.

System memory 16 may be the memory for device 10. System memory 16 may comprise one or more computer-readable storage media. Examples of system memory 16 include, but are not limited to, a random access memory (RAM), an electrically erasable programmable read-only memory (EEPROM), flash memory, or other medium that can be used to carry or store desired program code in the form of instructions and/or data structures and that can be accessed by a computer or a processor.

In some aspects, system memory 16 may include instructions that cause host host processor 12, GPU 14, and/or display processor 18 to perform the functions ascribed in this disclosure to host processor 12, GPU 14, and/or display processor 18. Accordingly, system memory 16 may be a computer-readable storage medium having instructions stored thereon that, when executed, cause one or more processors (e.g., host processor 12, GPU 14, and/or display processor 18) to perform various functions.

System memory 16 is a non-transitory storage medium. The term “non-transitory” indicates that the storage medium is not embodied in a carrier wave or a propagated signal. However, the term “non-transitory” should not be interpreted to mean that system memory 16 is non-movable or that its contents are static. As one example, system memory 16 may be removed from device 10, and moved to another device. As another example, memory, substantially similar to system memory 16, may be inserted into device 10. In certain examples, a non-transitory storage medium may store data that can, over time, change (e.g., in RAM).

In the techniques described in this disclosure, host processor 12 may instruct GPU 14 to render graphical image content. For instance, an application executing on host processor 12 may generate graphical image content for a wallpaper (e.g., background) to be displayed, another application executing on host processor 12 may generate graphical image content to indicate the time of day, another application execution on host processor 12 may generate graphical image content to indicate wireless signal strength (e.g., for a device supporting wireless communication such as a smartphone, tablet, computer, television, gaining console or the like), and so forth. A framework of host processor 12 (e.g., a software module executing on host processor 12, hardware on host processor 12, or a combination thereof) may instruct GPU 14 to render the graphical image content generated by each of these applications. One example of the framework of host processor 12 may be the operating system (OS) executing on host processor 12.

In turn, GPU 14 renders the graphical image content generated by each of these applications. For example, the respective graphical image content from respective applications may be considered as respective layers. Keeping with the above example, one layer is the wallpaper, another layer is the time information (i.e., time of day, as in representation of a clock time), another layer is wireless signal strength, and so forth. GPU 14 may store the resulting layers in a layer buffer in system memory 16.

Display processor 18 may retrieve the respective layers from the layer buffer in system memory 16 and compose the layers to form a single image frame. Display processor 18 may then output the image frame to display 19. Composing of the layers may be considered as stitching the layers together or otherwise combining the layers to form one image. As an example, the time information may overlap the background wallpaper, and display processor 18, as part of the composing, may cover the portion of the background wallpaper that is covered by the time information and display the time information on-top-of the background wallpaper.

One example way in which display processor 18 retrieves respective layers from the layer buffer in system memory 16 is based on commands from host processor 12. For instance, host processor 12 may execute a display compositor. The function of the display compositor may be to cause display processor 18 to retrieve layers from system memory 16.

There may be plurality of hardwired connection lines, referred to as pipes, between display processor 18 and system memory 16. Each pipe may be configured to retrieve one layer from system memory 16. The display compositor may cause host processor 12 to instruct display processor 18 to retrieve particular layers from particular pipes. As an example, display processor 18 may include a plurality of control registers. The value of the control registers indicates to display processor 18 that a layer is to be retrieved from system memory 16. Host processor 12, based on the execution of the display compositor, may set the control registers of the display processor 18 to have display processor 18 retrieve the layers from system memory 16 via the pipes.

The display compositor is generally a combination of a user mode driver and a kernel mode driver. The kernel mode driver is also referred to as a display processor driver. The user mode driver provides a high level of library calls that a software developer can use to define operations that display processor 18 is to perform. A compiler, executing on host processor 12 or on another device, may compile the user mode driver, and the compiled user mode driver may include instructions for the display processor driver (e.g., kernel mode driver). The display processor driver, when executed, may cause host processor 12 to interface with display processor 18. For instance, the display processor driver may cause host processor 12 to issue commands that are consumable (e.g., operable) by display processor 18, such as set register values and other such operation commands.

Although the display compositor is described as software executing on programmable circuitry of host processor 12, the example described in this disclosure are not so limited. In some examples, the display compositor may be a fixed-function circuitry of host processor 12, or may be firmware executing on programmable circuitry of host processor 12. Therefore, programmable circuitry, fixed-function circuitry, or a combination thereof of host processor 12 may be configured to cause host processor 12 to perform the example operations of the display compositor.

As described above, one of the functions of display processor 18 is to retrieve layers from system memory 16, where one or more layers may overlap other layers (e.g., the layer that illustrates the battery life may overlap the background layer). Because an overlapping layer occludes an overlapped layer, there may be power and system bandwidth gains if display processor 18 does not retrieve the portion of the overlapped layer that is occluded by the overlapping layer. For example, one of the commands that the display compositor may issue to display processor 18 is a command that defines a portion of a layer that display processor 18 is to avoid retrieving.

While the display compositor may be configured to determine which portions of which layer overlap which portions of other layers (e.g., based on the coordinates of where the layers are to be displayed on display 19), one issue may be present where the display compositor may not be able to accurately determine whether the overlapping portion of a first layer actually occludes the overlapped portion of a second layer.

In generating the image content of layer, GPU 14 determines a color value for each pixel of the layer. The color value of a pixel may be defined by four attributes: a red-component, a green-component, a blue-component, and an opacity value (also called alpha value or just alpha). Other color spaces are possible too.

The opacity value indicates how opaque a pixel is. A fully opaque pixel may completely occlude a pixel that the opaque pixel overlaps. A translucent pixel may not completely occlude a pixel that it overlaps. Rather, display processor 18 may blend the color values of a translucent pixel with the pixel that it overlaps, where the contribution to the final color value from the overlapping and overlapped pixel is based on the respective opacity values (e.g., the higher the opacity value for the overlapping pixel is, the greater its color value will contribute in the blending to generate the final color value). In this sense, for fully opaque pixels, display processor 18 may be considered as blending the fully opaque pixels with pixels that the fully opaque pixel overlaps, where the overlapped pixels do not contribute at all to the blending. Hence, the fully opaque pixel completely occludes all pixels that the fully opaque pixel overlaps.

Blending based on the opacity value is one example way in which display processor 18 may blend color values. However, there may be other example techniques that do not use the opacity values of each pixel, but still result in the opaque pixels occluding pixels that the opaque pixels overlap.

There may be various use cases for using a combination of translucent and opaque pixels in a layer. For instance, in rendering image content, host processor 12 may instruct GPU 14 to render pixels along a border of a layer to be partially translucent to form a so-called “shadowing” effect. This shadowing causes the layer to appear to pop out relative to the background layer given the perception of three-dimensional image even though the layers are two-dimensional. There may be other use cases for having translucent, opaque, and even clear (see through) pixels in a layer, and the examples should not be considered limited to the specific shadowing described in this disclosure.

Because parts of the layer that include the translucent or clear pixels do not occlude portions of the overlapped layers, the display compositor may cause display processor 18 to retrieve the entirety of each of the layers even though a majority of the overlapped layers may be occluded. For instance, assume a first layer includes the shadow effect where the first layer is completely opaque except for along the borders, and the first layer overlaps a second layer. In this example, if the display compositor instructed display processor 18 to avoid retrieving any portion of the second layer that is overlapped by the first layer, then display processor 18 may not blend the color values of the pixels along the border of the first layer with overlapped pixels in the second layer. The result may be that the shadow effect is not present. Therefore, to ensure that the shadow effect is present, the display compositor may cause display processor to retrieve the entire second layer even though a majority of the second layer will be occluded, which is power and memory bandwidth inefficient.

One example way to detect which parts of a layer occlude another layer is for the display compositor to evaluate the opacity value of each pixel of a layer that is overlapping a pixel of another layer, and then avoid retrieving pixels determined to be occluded. However, such pixel-by-pixel evaluation of opacity values may not be power and processing efficient. For instance, in a 1600×2560 surface, there will be approximately 4 million pixels, and there may be multiple surfaces. The power and latency needed to read the opacity values of each pixel may be greater than desired.

The example techniques described in this disclosure provide for a way to generate opacity information that the display compositor can use to determine portions of layers that do not need to be retrieved because they will be occluded. In addition, the display compositor may be configured to evaluate this opacity information in a way to efficiently (e.g., with limited clock cycles and power) determine which portions of the first layer are translucent and which portions of the first layer are opaque so that the display compositor can instruct display processor 18 to avoid retrieving portions of overlapped layers that are overlapped by the opaque portion of the first layer.

In some examples, processing circuitry of GPU 14, as part of the rendering, may generate opacity information on a block-by-block basis of a layer, indicating whether a block of pixels is opaque or not opaque. An opaque block is a block where substantially all pixels in the block are opaque (e.g., greater than 90% of pixels are opaque). A not opaque block is a block where at least one pixel in the block is not opaque. There may be various example sizes of the block of pixels of a layer such as 128×128, 512×512, etc. The block of pixels need not be square shaped and need not include an even number of rows or columns. By including opacity information on a block-by-block basis, computational efficiencies may be gained. For instance, evaluating opacity information of each pixel may be computationally expensive for the display compositor. However, evaluating opacity information on a block-by-block basis may not be computationally taxing because each block includes a plurality of pixels. For example, the opacity information for a block indicates whether all pixels of the block are opaque or at least one pixel of the block is not opaque. Therefore, each pixel does not need to be evaluated for its opacity information such as in cases where the block of pixels is opaque.

The display compositor may read the block-by-block opacity information for one or more blocks of a layer and, from the opacity information, determine which portions of the layer will occlude other layers, and which portions will not. In some examples, such as with shadow effect, the display compositor may read the opacity information of blocks of the layer in a particular order to decrease the time needed to identify opaque portions of the layer.

For example, the display compositor may begin reading opacity information for a block in a first corner of the layer and for a block in a second, diagonally opposite corner of the layer (e.g., the first corner may be the top-left corner of the layer and the second corner may be the bottom-right corner of the layer). For the shadow effect case, the opacity information for both of these blocks may indicate that at least one pixel in the blocks is not opaque. The display compositor may evaluate, in a diagonally inwards direction, the opacity information of blocks starting from respective corners until the display compositor identifies a first block starting from a first corner, where opacity information for the first block indicates that all pixels in the first block are opaque, and identifies a second block starting from a second corner, where opacity information for the second block indicates that all pixels in the second block are opaque.

The first and second blocks define diagonally opposite corners of an inner rectangular area. For example, if the display compositor identified the first block starting from the top-left corner of a layer, and identified the second block starting from the bottom-right corner of the layer, then the first block forms a top-left corner of an inner rectangular portion of the layer, and the second block form a bottom-right corner of the inner rectangular portion of the layer.

There is a relatively high likelihood that the identified first and second blocks define diagonally opposite corners of an inner rectangular portion of the layer that is hilly opaque, where areas outside the inner rectangular portion but still within the layer are translucent (e.g., to provide the shadowing effect). By evaluating the block level opacity information in a diagonally inward direction stalling from opposite corners of a layer, the display compositor may determine the inner rectangular portion by evaluating a relatively few number of blocks. To confirm that the inner rectangular portion of the layer is truly opaque, the display compositor may read the opacity information of each block in the inner rectangular portion and confirm that all pixels in each block are opaque.

The above is one example way in which to determine an inner rectangular portion of a layer that is opaque, and other example techniques may also be available. As one example, the display compositor may evaluate opacity information of blocks starting from a left-end column of the layer. If the column includes one block that is not opaque, the display compositor may proceed to the next column, and repeat these operations until the display compositor identifies a column having only opaque blocks. The display compositor may identify this column as a left boundary of the inner rectangular portion. The display compositor may evaluate opacity information of blocks starting from a right-end column of the layer. If the column includes one block that is not opaque, the display compositor may proceed to the next column, and repeat these operations until the display compositor identifies a column having only opaque blocks. The display compositor may identify this column as a right boundary of the inner rectangular portion.

The display compositor may perform similar operations for the top and bottom rows of the layer. For example, the display compositor may evaluate opacity information of blocks starting from a top row of the layer. If the row includes one block that is not opaque, the display compositor may proceed to the next row, and repeat these operations until the display compositor identifies a row having only opaque blocks. The display compositor may identify this row as a top boundary of the inner rectangular portion. The display compositor may evaluate opacity information of blocks starting from a bottom row of the layer. If the row includes one block that is not opaque, the display compositor may proceed to the next row, and repeat these operations until the display compositor identifies a row having only opaque blocks. The display compositor may identify this row as a bottom boundary of the inner rectangular portion.

The intersection block of the top boundary and the left boundary may be the top-left block of the inner rectangular portion, the top boundary and the right boundary may be the top-right block of the inner rectangular portion, the bottom boundary and the left boundary may be the bottom-left block of the inner rectangular portion, and the bottom boundary and the right boundary may be the bottom-right block of the inner rectangular portion. As above, the display compositor may confirm that all blocks in the inner rectangular portion are opaque.

Once the display compositor determines an inner rectangular portion of a layer that is opaque, the display compositor may utilize information of the location of the inner rectangular layer to determine portions of one or more layers that are occluded by the inner rectangular portion. For instance, the display compositor may map the location of the inner rectangular portion of the layer to locations on the overlapped layers, and instruct the display processor to not retrieve, for use in composing the plurality of layers, areas of an overlapped layer that are occluded by the inner rectangular portion of the overlapping layer. As an example, the display compositor may determine the location of the inner rectangular portion of the overlapping layer on display 19, and back calculate to determine which areas of the overlapped layers are going to be located at the same location as the inner rectangular portion of the overlapping layer. Based on these calculations, the display compositor may determine which areas of the overlapping layers display processor 18 is to not retrieve from system memory 16, thereby saving power and memory bandwidth.

It should be understood that although host processor 12, via a display compositor, is described as implementing the example techniques described in this disclosure, the techniques should not be considered so limited. In general, the techniques described in this disclosure may be performed by processing circuitry. Processing circuitry refers to circuit components (e.g., integrated circuit components) that are configured to perform the example techniques. For instance, host processor 12 is one example of the processing circuitry. Display processor 18 may be another example of the processing circuitry. In some cases, the processing circuitry may include both host processor 12 and display processor 18. For ease of description, the examples are described with respect to host processor 12, but the techniques may be implemented more generally with any of a variety of processing circuitry such as GPU 14 or display processor 18. Furthermore, GPU 14 may not be the only circuit that generates the image content. Other processing circuitry may also generate image content.

In general, the techniques described in this disclosure may be performed by processing circuitry. Examples of processing circuitry include programmable circuitry, fixed-function circuitry, or a combination thereof.

Device 10 may also include display 19, user interface 20, and transceiver module 22. Device 10 may include additional modules or units not shown in FIG. 1 for purposes of clarity. For example, device 10 may include a speaker and a microphone, neither of which are shown in FIG. 1, to effectuate telephonic communications in examples where device 10 is a mobile wireless telephone. Furthermore, the various modules and units shown in device 10 may not be necessary in every example of device 10. For example, user interface 20 and display 19 may be external to device 10 in examples where device 10 is a desktop computer. As another example, user interface 20 may be part of display 19 in examples where display 19 is a touch-sensitive or presence-sensitive display of a mobile device. As yet another example, user interface 20 may be an interface configured to receive voice commands.

Display 19 may comprise a liquid crystal display (LCD), a cathode ray tube (CRT) display, a plasma display, a touch-sensitive display, a presence-sensitive display, or another type of display device. Examples of user interface 20 include, but are not limited to, a trackball, a mouse, a keyboard, and other types of input devices including a microphone to receive voice commands. User interface 20 may also be a touch screen and may be incorporated as a part of display 19. Transceiver module 22 may include circuitry to allow wireless or wired communication between device 10 and another device or a network. Transceiver module 22 may include modulators, demodulators, amplifiers and other such circuitry for wired or wireless communication.

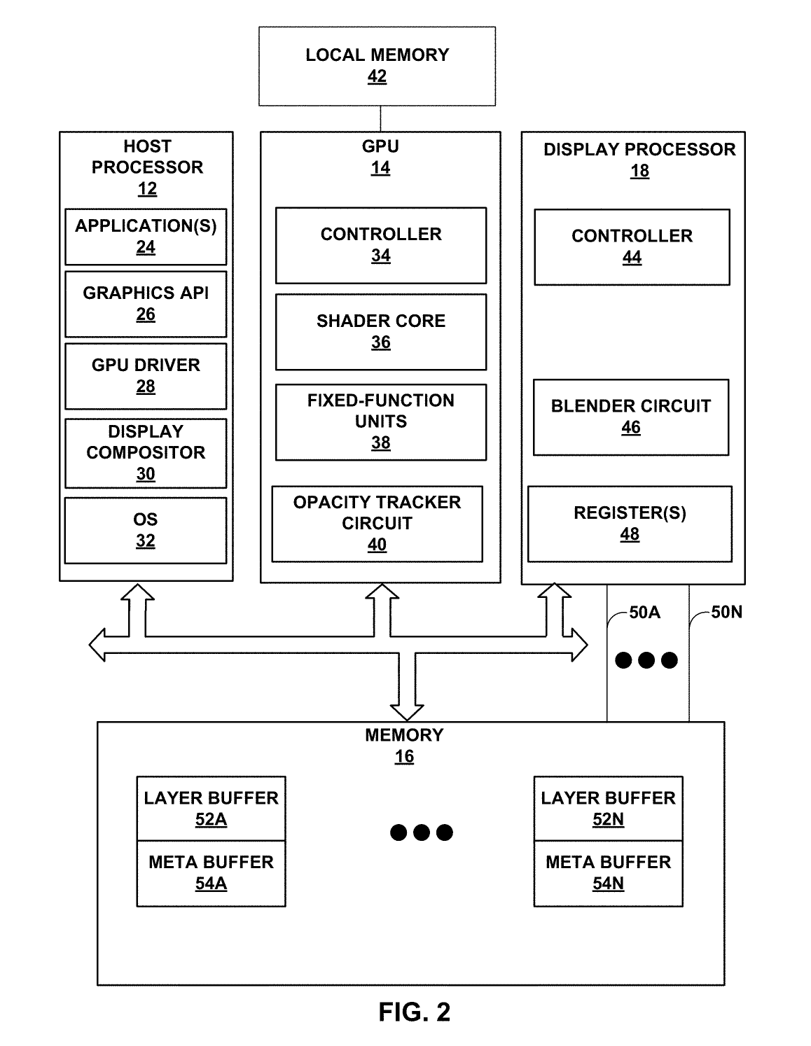

FIG. 2 is a block diagram illustrating components of the device illustrated in FIG. 1 in greater detail. FIG. 2 illustrates host processor 12, GPU 14, display processor 18, and memory 16 of FIG. 1 in greater detail. As shown in FIG. 2, host processor 12. GPU 14, display processor 18, and memory 16 are communicatively coupled to another. GPU 14 and display processor 18 may, in some examples, be integrated onto a motherboard with host processor 12. In additional examples, GPU 14 may be implemented on a graphics card that is installed in a port of a motherboard that includes host processor 12 and display processor 18. In further examples, GPU 14 and/or display processor 18 may be incorporated within a peripheral device that is configured to interoperate with host processor 12. In additional examples, GPU 14 and display processor 18 may be located on the same processing circuitry as host processor 12 forming a system on a chip (SoC).

Host processor 12 is configured to execute application 24, a graphics API 26, a GPU driver 28, a display compositor 30, and an operating system (OS) 32. Display compositor 30 is described as being software executing on programmable circuitry, but may be fixed-function circuitry or a combination of fixed-function circuitry and programmable circuitry.

GPU 14 includes a controller 34, shader core 36, one or more fixed-function units 38, and opacity tracker circuit 40. GPU 14 is illustrated as communicatively coupled to local memory 42. Local memory 42 may be any example of memory available to be accessed by GPU 14. Local memory 42 may be referred to as a scratch buffer, examples of which include the graphics memory of GPU 14, an L3 cache, a memory heap allocated to GPU 14, and may possibly also include memory within memory 16. Other examples of local memory 42 are possible, and the local memory is generally any memory to which GPU 14 has access.

GPU 14 is an example of processing circuitry configured to generate image content for display on display 19 (FIG. 1). As an example, GPU 14 may generate layers of image content. Each layer may be a rectangle image that encompasses a portion or all of display 19. One layer may overlay on top of another layer, where two layers encompass the same area on display 19, or one or more the layers may be in separate portions than other layers. As an example, GPU 14 may generate a plurality of layers that are respectively stored in layer buffers 52A-52N (collectively layer buffers 52) of memory 16.

Display processor 18 includes controller 44, blender circuit 46, and one or more registers 48. As described in more detail, display compositor 30 may store values in one or more registers 48 that indicate how much image content to retrieve from system memory 16, from where in system memory 16 to retrieve the image content (e.g., how much of each one of layer buffers 52 to read), where the retrieved image content is to be displayed on display 19, and the order of the layers of image content (e.g., which layer is in front of which layer, also referred to as Z order). One of one or more registers 48 may store information that indicates portions of a layer that is not be retrieved from system memory 16, such as portions of a layer that are occluded by portions of another layer. One of one or more registers 48 may be a hardware kickoff register, where if the value of the hardware kickoff register is a particular value, display processor 18 may perform its example functions.

As an example, controller 44, which may be fixed-function or programmable circuitry of display processor 18, may repeatedly poll the hardware kickoff register. When controller 44 determines that the hardware kickoff register stores the value indicating that display processor 18 is to perform its functions, controller 44 may read the other ones of registers 48 to determine what image content to retrieve and from where to retrieve the image content stored in system memory 16, including information indicating what image content not to retrieve for a layer. Controller 44 may read the image content data for one or more layers stored in one or more of layer buffers 52 via one or more pipes 50A-50N (collectively pipes 50). Pipes 50 may provide a direct connection to memory 16, and display processor 18 may be able to read one layer per one of pipes 50. For example, display processor 18 may read image content of a first layer from layer buffer 52A via pipe 50A, read image content of a second layer from layer buffer 52B via pipe SOB, and so forth.

Blender circuit 46 may blend the image content from the various layers. Blender circuit 46 may perform the blending in accordance with one or more different example techniques. For instance, blender circuit 46 may perform blending in accordance with the multiply blend operation where if two pixels in two different layers overlap, the color values are multiplied. As another example, blender circuit 46 may perform the blend in accordance with the screen blend operation where if two pixels in two different layers overlap, the blender circuit 46 inverts the color values, multiplies them, and inverts the resulting value.

As yet another example, blender circuit 46 may perform the blend in accordance with the overlay blend operation which is a combination of the multiply and screen blend operations. In the overlay blend, blender circuit 46 may apply the multiply blend to overlapping pixels where the overlapping layer (e.g., the one on top) is darker, and apply the screen blend to overlapping pixels where the overlapping layer is lighter.

As additional example, blender circuit 46 may perform alpha compositing. In alpha compositing, blender circuit 46 may use the opacity value of each pixel to determine how to blend the pixels. For instance, the opacity value of a pixel indicates how much that pixel contributes to the final pixel value. Other possible ways to perform the blending operation are possible and the above are merely a few to assist with understanding.

Display processor 18 may be configured operate in as a parallel engine. For example, display processor 18 may read a first row from each of the layers stored in respective layer buffers 52 via respective pipes 50, blend the pixel values of the layers where there is overlap via blender circuit 46, and output the blended pixel values for storage and later retrieval by display 19. Display processor 18 may repeat these operations for each row from each of the layers stored in respective layer buffers 52.

The layers that are stored in layer buffers 52 may be generated in response to execution of one or more applications 24. For instance, one or more applications may include at least some of one or more instructions that cause graphic content to be displayed. One example of applications 24 may be an application that executes and indicates the time and date. One example of applications 24 may be an application that executes and indicates the power level and connectivity information. One example of applications 24 may be a video game application that executes and generates graphics content of a video game. Applications 24 may not be the only applications generating image content. For instance, operating system 32 may be generating image content for a background.

In general, the image content generated by each one of one or more applications 24 or operating system 32 may be its own separate layer of image content. Also, there may be other ways in which layers of image content are generated, such as be components other than applications 24 executing on host processor 12.

One or more applications may offload the task of rendering the image content for each of the layers to GPU 14, which may be specialized hardware that can perform parallel operations in a single instruction multiple data (SIMD) hardware architecture. Rendering image content may include performing many of the same mathematical operations in parallel (e.g., same instruction but for different data), and therefore, the SIMD hardware architecture of GPU 14 may be well suited for such operations.

To perform the rendering, one or more applications 24 may issue instructions to graphics API 26. Graphics API 26 may be a runtime service that translates the instructions received from software applications 24 into a format that is consumable by GPU driver 28. In some examples, graphics API 26 and GPU driver 28 may be part of the same software service.

GPU driver 28 receives the instructions from applications 24, via graphics API 26, and controls the operation of GPU 14 to service the instructions. For example, GPU driver 28 may formulate one or more command streams, place the command streams into memory 16, and instruct GPU 14 to execute command streams. GPU driver 28 may place the command streams into memory 16 and communicate with GPU 14 via operating system 32 (e.g., via one or more system calls).

Controller 34 of GPU 14 is configured to retrieve the commands stored in the command streams, and dispatch the commands for execution on shader core 36 and one or more fixed-function units 38. Controller 34 may dispatch commands from a command stream for execution on one or more fixed-function units 38 or a subset of shader core 36 and one or more fixed-function units 38. Controller 34 may be hardware, fixed-function circuitry of GPU 14, may be programmable circuitry of GPU 14 for executing software or firmware, or a combination of both.

Shader core 36 includes programmable circuitry (e.g., processing cores on which software executes). One or more fixed-function units 38 include fixed function circuitry configured to perform limited operations with minimal functional flexibility. Shader core 36 and one or more fixed-function units 38 together form a graphics pipeline configured to perform graphics processing.

Shader core 36 may be configured to execute one or more shader programs that are downloaded onto GPU 14 from host processor 12. A shader program, in some examples, may be a compiled version of a program written in a high-level shading language (e.g., an OpenGL Shading Language (GLSL), a High Level Shading Language (HLSL), a C for Graphics (Cg) shading language, etc). In some examples, shader core 36 may include a plurality of processing units that are configured to operate in parallel (e.g., a SIMD pipeline). Shader core 36 may have a program memory that stores shader program instructions and an execution state register (e.g., a program counter register) that indicates the current instruction in the program memory being executed or the next instruction to be fetched. Examples of shader programs that execute on shader core 36 include, for example, vertex shaders, pixel shaders (also referred to as fragment shaders), geometry shaders, hull shaders, domain shaders, compute shaders, and/or unified shaders.

Fixed-function units 38 may include hardware that is hard-wired to perform certain functions. Although the fixed function hardware may be configurable, via one or more control signals, for example, to perform different functions, the fixed function hardware typically does not include a program memory that is capable of receiving user-compiled programs. In some examples, one or more fixed-function units 38 may include, for example, processing units that perform raster operations (e.g., depth testing, scissors testing, alpha blending, etc.)

GPU driver 28 of host processor 12 may be configured to write the command streams to memory 16, and controller 34 of GPU 14 may be configured to read the one or more commands of command streams from memory 16. In some examples, one or both of command streams may be stored as a ring buffer in memory 16. A ring buffer may be a buffer with a circular addressing scheme where host processor 12 and GPU 14 maintain synchronized state variables associated with the writing of data to and reading of data from the ring buffer. For example, if the first command stream is a ring buffer, each of host processor 12 and GPU 14 may store a write pointer indicating the next address to be written to in the ring buffer, and a read pointer indicating the next address to be read from in the ring buffer.

When host processor 12 writes a new command to the ring buffer, host processor 12 may update the write pointer in host processor 12 and instruct GPU 14 to update the write pointer in GPU 14. Similarly, when GPU 14 reads a new command from the ring buffer, GPU 14 may update the read pointer in GPU 14 and instruct host processor 12 to update the read pointer in host processor 12. Other synchronization mechanisms are possible. When the read and/or write pointers reach a highest address in the range of addresses allocated for the ring buffer, the read and/or write pointers may wrap around to the lowest address to implement a circular addressing scheme.

Example operation of an example GPU driver 28 and an example GPU controller 34 is now be described with respect to FIG. 2. GPU driver 28 receives one or more instructions from one or more applications 24 that specify graphics operations and/or general-purpose computing operations to be performed by GPU 14. GPU driver 28 places the output command stream into memory 16, which is accessible by GPU controller 14. GPU driver 28 notifies GPU controller 34 that the command stream corresponding to one or more applications 24 is available for processing. For example, GPU driver 28 may write to a GPU register (e.g., a GPU hardware register polled by controller 34) one or more values indicating that the command stream is ready for execution.

Upon notification that the command stream is ready for execution, controller 34 of GPU 14 may determine if resources are currently available on GPU 14 to begin executing the command stream. If resources are available, controller 14 begins to dispatch the commands in the command stream.

As GPU 14 completes the rendering of image content of each one of applications 24, GPU driver 28 instructs GPU 14 to store the image content in specific locations in memory 16. For example, for a first one of applications 24, GPU driver 28 may instruct controller 34 to store the image content for that application in layer buffer 52A. The image content for an application of applications 24 may be pixel values for a plurality of pixels of the image content, where the image content forms a layer of image content. For a second one of applications 24, GPU driver 28 may instruct controller 34 to store the image content for that application in layer buffer 52B, and so forth.

Display compositor 30 may be configured to instruct display processor 18 to retrieve the layers stored in layer buffers 52, and blend the layers to generate a composite frame for display on display 19. As one example, display compositor 30 may instruct display processor 18 to blend the layers and generate a composite frame periodically, e.g., every 16.67 milli-seconds to achieve a refresh rate of display 19 of 60 frames per second (fps). As another example, operating system 32 may instruct display compositor 30 to instruct display processor 18 to generate a composite frame.

As described above, for display compositor 30 to instruct display processor 18 to generate a composite frame, display compositor 30 may set a hardware kickoff register of one or more registers 48 to a value that causes controller 44 to read layer buffers 52 via pipes 50. In addition, operating system 32 or GPU driver 28 may instruct display compositor 30 with information indicating how much of each one of layer buffers 52 is to be retrieved, where each of the layers is going to be displayed on display 19, and the order of the layers (e.g., which layer overlaps which other layer). For instance, display compositor 30 may load registers 48 with such information that controller 44 reads for retrieving layers stored in layer buffers 52 with pipes 50.

One issue may be present where display processor 18 reads image content (e.g., pixel values of pixels) of a layer that is subsequently occluded by another layer. In this case, reading pixel values of pixels that are subsequently occluded and therefore do not contribute to the final blended pixel values may be unnecessary, and a waste of bandwidth and processing time.

The examples described in this disclosure provide for a way to determine which portions of which layers not only overlap which portions of other layers but occlude portions of other layers. In this way, retrieving portions of layers that are occluded can be avoided, resulting in less wasted computation and bandwidth consumption.

One way to determine if a pixel in a layer is occluded by another pixel in a layer would be for display compositor 30 to evaluate the opacity values on a pixel-by-pixel basis. However, the number of pixels in a frame may be in the millions, making evaluating the opacity value for each pixel processing inefficient.

As illustrated, GPU 14 includes opacity tracker circuit 40, which may store information on a block-by-block basis indicating whether a block of pixels is opaque. A block of pixels is opaque if all pixels (or at least above a threshold number of pixels) in the block are opaque and a block of pixels is not opaque if at least one pixel in the block is not opaque. Opacity tracker circuit 40 may store the opacity information for each block of a layer in local memory 42 (e.g., either directly or via controller 34). For instance, a register in GPU 14 may include the address for local memory 42, and opacity tracker circuit 40 or controller 34 may store the opacity information for each block based on the address for local memory 42 in the register in GPU 14. The opacity information may be an opacity value for each block, where a first opacity value indicates that all pixels in the block are opaque, and a second opacity value, different than the first opacity value, indicates that at least one pixel in the block is not opaque.

After rendering, opacity tracker circuit 40 may evaluate the pixel values of pixels in a block of a layer, where the block is of size N×M, where N represents the number of columns and, M represents the number of rows, and N and M may be equal to one another, or different than one another. Opacity tracker circuit 40 may count pixels of a block and evaluate the opacity value for each pixel of the block. If opacity tracker circuit 40 reaches the end of the N×M sized block and each pixel in the block is opaque, then opacity tracker circuit 40 may store a first opacity value, as the opacity information for the block, that indicates that the block is opaque. If opacity tracker circuit 40 identifies a pixel in the N×M sized block that is not opaque before reaching the end of the N×M sized block, then opacity tracker circuit 40 may store a second opacity value, as the opacity information for the block, that indicates that the block is not opaque.

As an example, as controller 34 is outputting pixel values to store in respective ones of layer buffers 52, the pixel values may pass through opacity tracker circuit 40. Controller 34 may output pixel values in a row-by-row manner. In this example, as a row of pixels is passing through opacity tracker circuit 40, opacity tracker circuit 40 may determine when N pixels have passed through, and after N pixels have passed through, opacity tracker circuit 40 may determine that a first row of an N×M block has passed through. After controller 34 outputs a first row, opacity tracker circuit 40 may determine how many sets of N number of pixels passed through.

For instance, if N×M is sized 128×128, and there are 1280 pixels in a row, after controller 34 outputs a row, opacity tracker circuit 40 may determine that there are 10 sets of N number of pixels (e.g., 1280/128). Opacity tracker circuit 40 may evaluate opacity values of each row of pixels as it passes through, until M number of rows pass through opacity tracker circuit 40. For instance, after 128 rows pass through, there will be pixel values for each 128×128 block of pixels.

In this way, opacity tracker circuit 40 may evaluate the pixel values of each N×M sized block (e.g., 128×128 block). If during the passing of pixel values as they are being written to system memory 16, opacity tracker circuit 40 determines that the opacity value of a pixel in one of the N×M blocks indicates that the pixel is not opaque, then opacity tracker circuit 40 may determine that that N×M block is not opaque, and store a value in local memory 42 that corresponds to that block indicating that the block is not opaque. If during the passing of pixel values as they are being written to system memory 16, opacity tracker circuit 40 determines that the opacity value of all pixels in one of the N×M blocks indicates that all pixels are opaque, then opacity tracker circuit 40 may determine that that N×M block is opaque, and store a value in local memory 42 that corresponds to that block indicating that the block is opaque.

In this way, local memory 42 may store a bitmap indicating on a block-by-block basis whether a block of pixels of a layer is opaque. For example, if the layer is of size 1280×2560, and each block is 128×128, then there will be 10×20 (=200) opacity values in local memory 42, where each of the 10×20 opacity values corresponds to one of the 128×128 blocks in the 1280×2560 layer.

In the illustrated example of FIG. 2, GPU driver 28 may associate the bitmap indicating opacity information for a layer with that layer. For example, after opacity tracker circuit 40 determines opacity information for layer, as stored in local memory 42, GPU driver 28 may store that bitmap in a memory location that is also accessible by display compositor 30. As one example, GPU driver 28 may store the bitmap indicating the opacity information of layer in memory 16; however, other locations are possible.

For example, GPU driver 28 may store the opacity information for the layer stored in layer buffer 52A in meta buffer 54A, store the opacity information for the layer stored in layer buffer 52B in meta buffer 54B, and so forth for layer buffer 52N and meta buffer 54N. GPU driver 28 may store information associating meta buffer 54A with layer buffer 52A (e.g., associating each respective meta buffer 54 to its layer buffer 52).

Display compositor 30 may use this block level opacity information stored in respective ones of meta buffers 54 to identify rectangular portions within a layer that are substantially opaque. Examples of substantially opaque portions are those having generally greater than 90% opacity as an example. Once display compositor 30 determines rectangular portions within a layer that are substantially opaque, display compositor 30 may set one or more registers 48, associated with information identifying portions not to retrieve, to values that identify which portions of overlapped layers are not be retrieved from memory 16.

As an example, for achieving a pop out effect, pixels along a border of a layer may be gray and translucent, which causes the whole layer to appear as if it is popping out. The gray and translucent pixels along a border of layer give the layer a shadow effect.

For such examples, the entire layer may be opaque except along the border. The layer may include an inner rectangular portion that is substantially opaque (e.g., greater than 90% opaque), and a border portion that is not opaque. Display compositor 30 may use the block level opacity information to determine the inner rectangular portion of a layer that is substantially opaque.

To determine the inner rectangular portion of a layer that is substantially opaque, display compositor 30 may evaluate, in a diagonally inward direction, the opacity information starting from a first block and a second block of a first layer. As one example, the first block may be the top-left block of the first layer, and the second block may be the bottom-right block of the first layer.

Display compositor 30 may identify a third block starting from the first block (e.g., starting from the top-left block), where the opacity information for the third block, as read from a respective one of meta buffer 54, indicates that all pixels in the third block are opaque. Display compositor 30 may also identify a fourth block starting from the second block (e.g., starting from the bottom-right block), where the opacity information for the fourth block, as read from the respective one of meta buffer 54, indicates that all pixels in the fourth block are opaque.

In this example, evaluating in a diagonally inward direction means that display compositor 30 evaluates one block, and then a block located diagonally below the block when starting from the top of the layer, or a block located diagonally above the block when starting from the bottom of the layer. For example, display compositor 30 may evaluate the top-left block of the layer, and the top-left block may not be opaque due to the shadow effect). Display compositor 30 may next evaluate the block that is located to the right and bottom of the top-left block, and determine whether this block is opaque or not. In this case, display compositor 30 evaluated blocks in a diagonally inward direction, where inward is towards the center of the layer. Similarly, display compositor 30 may evaluate the bottom-right block of the layer, and the bottom-right block may not be opaque (e.g., due to the shadow effect). Display compositor may next evaluate the block that is located to above and left of the bottom-right block, and determine whether this block is opaque or not. As above, in this case, display compositor 30 evaluated blocks in a diagonally inward direction, where inward is towards the center of the layer.

Display compositor 30 may determine the inner rectangular portion of the layer based on the location of the third block and the fourth block. For example, the third block may establish one corner of the inner rectangular portion (e.g., the third block may be in the top-left corner of the inner rectangular portion and the fourth block may establish a diagonally opposite corner of the inner rectangular portion (e.g., the fourth block may be in the bottom-right corner of the inner rectangular portion). With the third and fourth blocks in the diagonally opposite corners, the display compositor 30 may define the four corners of the inner rectangular portion as follows: the first corner is the third block, the second corner has the same y-coordinate as the third block, and the same x-coordinate as the fourth block, the third corner has the same x-coordinate as the third block, and the same y-coordinate as the fourth block, and the fourth corner is the fourth block.

As another example way to determine the inner rectangular portion, display compositor 30 may evaluate opacity information of blocks in a layer on a column-by-column basis and a row-by-row basis starting from respective ends of the layer (e.g., top, bottom, left, and right) and move inwards (e.g., towards the center of the layer). For example, display compositor 30 may evaluate opacity information of blocks in the leftmost column and if a block in the leftmost column is not opaque, proceed to the next column until display compositor 30 identifies a left boundary column having folly opaque blocks, and store the x-coordinate of the left boundary column. Display compositor 30 may evaluate opacity information of blocks in the rightmost column and if a block in the rightmost column is not opaque, proceed to the next column until display compositor 30 identifies a right boundary column having fully opaque blocks, and store the x-coordinate of the right boundary column. Display compositor 30 may evaluate opacity information of blocks in the topmost row and if a block in the topmost row is not opaque, proceed to the next row until display compositor 30 identifies a top boundary column having fully opaque blocks, and store the y-coordinate of the top boundary row. Display compositor 30 may evaluate opacity information of blocks in the bottommost row and if a block in the bottommost row is not opaque, proceed to the next row until display compositor 30 identifies a bottom boundary row having fully opaque blocks, and store the y-coordinate of the bottom boundary row.

Display compositor 30 may define the x, y coordinate of the intersection of the left boundary and the top boundary as the top-left block of the inner rectangular portion, define the x, y coordinate of the intersection of the right boundary and the top boundary as the top-right block of the inner rectangular portion, define the x, y coordinate of the intersection of the bottom boundary and the left boundary as the bottom-left block of the inner rectangular portion, and define the x, y coordinate of the intersection of the bottom boundary and the right boundary as the bottom-right block of the inner rectangular portion.

Once display compositor 30 determines the inner rectangular portion of a layer using the above example techniques, display compositor 30 may confirm that the inner rectangular portion of a layer is truly opaque (e.g., there is not a block in the middle of the inner rectangular portion that is not opaque). Display compositor 30 may evaluate opacity information in each block in the inner rectangular portion (e.g., in a raster scan order), as available from respective meta buffers 54. Display compositor 30 may confirm that the inner rectangular portion is opaque based on opacity information for each block in the inner rectangular portion indicating that all pixels in each block in the inner rectangular portion is opaque.

At this juncture, display compositor 30 may have determined the coordinates for the inner rectangular portion, and may have confirmed that the inner rectangular portion is opaque. However, display compositor 30 may need to perform additional mapping operations to determine where the inner rectangular portion of a first layer is located in other layers (e.g., a second layer) that the first layer overlaps.

As described above, one or more registers 48 may store information, written by display compositor 30, indicating what image content of layer and from where the image content of the layer is to be retrieved. These registers of registers 48 may be referred to as source registers that store source information. The source registers may include information such as top-left, bottom-right coordinates of image content to retrieve, and the one of layer buffers 52 from which to retrieve the image content. As an example, a source register may store source coordinate information such as (0.0, 0.0, 1600.0, 2308.0) in layer buffer 52A indicating that display processor 18 is to retrieve the image content from (0.0, 0.0) to (1600.0, 2308.0) from layer buffer 52A.

In addition to source registers, one or more registers 48 may include a frame register, also called destination register. The frame register indicates the location on display 19 where the layer is to be displayed. For instance, for the layer stored in layer buffer 52A, the frame register may store frame coordinate information such as (0, 84, 1600, 2392). This means that the image content for the layer stored in layer buffer 52A that display processor 18 retrieved is to be displayed from (0, 84) to (1600, 2392) on display 19.

Also, for each of the layers, there may be depth value (or Z order) that indicates which layer is on top, which layer is below that layer, and so forth. The depth value may be stored in one of registers 48 or may be stored in meta buffer 54 for corresponding layers. As an example, a layer with Z order value of 0 is the backmost layer, a layer with a Z order value of 1 is above the backmost layer, and so forth. Although each layer may be assigned a Z order value, not all layers may be overlapped with another layer. For example, one layer with a lower Z order value may be in a first location on display 19, and another layer with a higher Z order value may be in a second location on display 19 that does not overlap with the first location. In particular, the sizes of the layer may be such that these layers are not overlapping one another.

After display compositor 30 determines the coordinates of the inner rectangular portion, the coordinates may be in terms of the source coordinates. However, the source coordinates for the inner rectangular portion of the first layer may not map directly to the coordinates for other layers because the source coordinates for the other layers may not have the same starting point as the source coordinates for the first layer, and the source coordinates for the other layers may map to different locations on the frame.

Accordingly, display compositor 30 may map the coordinates for the inner rectangular portion of the first layer to the frame coordinates. For instance, in the example where the source coordinates for the first layer are (0.0, 0.0, 1600.0, 2308.0) and the frame coordinates for the first layer are (0, 84, 1600, 2392), the frame coordinates may be considered as the source coordinates but shifted downwards by 84 pixels (e.g., the y-coordinates for the top-left and bottom-right corners are shifted downwards 84 pixels).

To map the source coordinates of the inner rectangular portion of the first layer to its frame coordinates, display compositor 30 may add 84 to the respective y-coordinates for the top-right and bottom-left corners of the inner rectangular portion. The result of this operation is the location of the inner rectangular portion on display 19 (e.g., the frame coordinates of the inner rectangular portion).

Display compositor 30 may then evaluate the frame coordinates for each of the other layers that are below the first layer (as indicated by the Z order value for each layer), and determine whether the inner rectangular portion overlaps any of these other layers. For example, if all or some of the frame coordinates of the inner rectangular portion of the first layer are within frame coordinates of other layers that are overlapped by the first layer, then the inner rectangular portion occludes at least a portion of these other layers.

One of one or registers 48 may be an occlusion register. The occlusion register may store source coordinate values for layers and indicates which area of a layer is not to be retrieved from system memory 16. With occlusion registers, controller 44 may retrieve image content of a layer except for the area of the layer identified by the occlusion register. This may reduce the amount of image content display processor 18 needs to retrieve.

In the above example, display compositor 30 may have determined frame coordinates for areas of layers that are occluded by the inner rectangular portion of the first layer. However, since controller 44 retrieves image content of a layer based on the source coordinates, display compositor 30 may need to convert the frame coordinates of areas of layers that are occluded by the inner rectangular portion to source coordinates.

For instance, in the above example, the frame coordinates for the first layer were the source coordinates for the first layer plus 84 pixels for the v-coordinates (e.g., source coordinates were (0.0, 0.0, 1600.0, 2308.0) and frame coordinates (0, 84, 1600, 2392)). Assume that for a second layer, the frame coordinates for the second layer are the same as the source coordinates for the second layer plus shifts of 10 pixels in the x-coordinate and 50 pixels in the y-coordinate. Also, assume that an inner rectangular portion of the first layer occludes an area of the second layer.

In this example, display compositor 30 may determine the frame coordinates of the inner rectangular portion of the first layer, and determine that the inner rectangular portion of the first layer occludes an area of the second layer based on the frame coordinates of the inner rectangular portion and the frame coordinates of the area of the second layer. Display compositor 30 may convert the frame coordinates of the area of the second layer back to the source coordinates of the second layer. For instance, in this example, display compositor 30 may add 10 to the x-coordinate of the top-left corner and the x-coordinate of the bottom-right corner of the frame coordinates of the area of the second layer, and add 50 to the y-coordinate of the top-left corner and the y-coordinate of the bottom-right corner of the frame coordinates of the area of the second layer to determine the source coordinates of the area of the second layer.

Display compositor 30 may store the source coordinate values for the area of the second layer that is occluded by the inner rectangular portion of the first layer in the occlusion register of the second layer. Then, when display processor 18 reads image content of the second layer, display processor 18 may not retrieve, for use in composing the plurality of layers, the area of the second layer that is occluded by the inner rectangular portion of the first layer.

Accordingly, FIG. 2 illustrates an example where display processor 18 is configured to compose a plurality of layers of image content to generate an image frame for display. For example, blender circuit 46 may blend together different layers to generate the image frame for display. GPU 14, which is an example of processing circuitry, may be configured to generate opacity information for one or more blocks of pixels of a first layer of the plurality of layers. The opacity information (e.g., opacity values for the blocks) indicates whether all pixels in a block are opaque or at least one pixel in the block is not opaque.

Host processor 12 may be configured, via execution of display compositor 30, to read the opacity information for one or more blocks of pixels of the first layer. For example, GPU 14 may store the pixel values for layers in respective ones of layer buffer 52, and host processor 12 may read opacity information stored in corresponding ones of meta buffer 54 for one or more blocks of pixels of the first layer. Host processor 12 (e.g., based on the execution of display compositor 30) may determine an inner rectangular portion of the first layer that is substantially opaque (e.g., greater than 90% opaque) based on the read opacity information. Host processor 12 (e.g., based on the execution of display compositor 30) may instruct display processor 18 to not retrieve memory 16 an area of a second layer of the plurality of layers that is occluded by the inner rectangular portion of the first layer (e.g., by storing information in the occlusion register for the second layer indicating source coordinates for areas that are not to be retrieved).

To determine the inner rectangular portion, host processor 12 may evaluate, in a diagonally inwards direction, the opacity information starting from a first block (e.g., top-left block) and a second block (e.g., bottom-right block) in the first layer. Host processor 12 may identify a third block starting from the first block, and a fourth block starting from the second block, where the third block and the fourth block are opaque. In this example, host processor 12 may determine one corner (e.g., top-left corner) of the third block to be one corner (e.g., top-left corner) of the inner rectangular portion, and determine one corner (e.g., bottom-right corner) of the fourth block to be one corner (e.g., bottom-right corner) of the inner rectangular portion. The result of these operations may be the screen coordinates of the inner rectangular portion of the first layer.

Host processor 12, based on the execution of display compositor 30, may determine coordinates of the area in the second layer based on the inner rectangular portion of the first layer. For example, host processor 12 may convert the source coordinates of the inner rectangular portion of the first layer to frame coordinates of the inner rectangular portion of the first layer. Host processor 12 may compare the frame coordinates of the inner rectangular portion of the first layer to frame coordinates of second layer and determine an area of the second layer, in frame coordinates, that the inner rectangular portion of the first layer overlaps and occludes. Host processor 12 may convert the frame coordinates of the area (e.g., occluded area) in the second layer to screen coordinates of the area in the second layer. Host processor 12 may instruct display processor 18 to not retrieve, for use in composing the plurality of layers, an area of the second layer of the plurality of layers that is occluded by the inner rectangular portion of the first layer.

To compose the layers, display processor 18 may retrieve image content of the first layer, and retrieve image content of the second layer except for the area of the second layer that is occluded by the inner rectangular portion of the first layer. Display processor 18 may blend the retrieved image content of the first layer and the retrieved image content of the second layer.

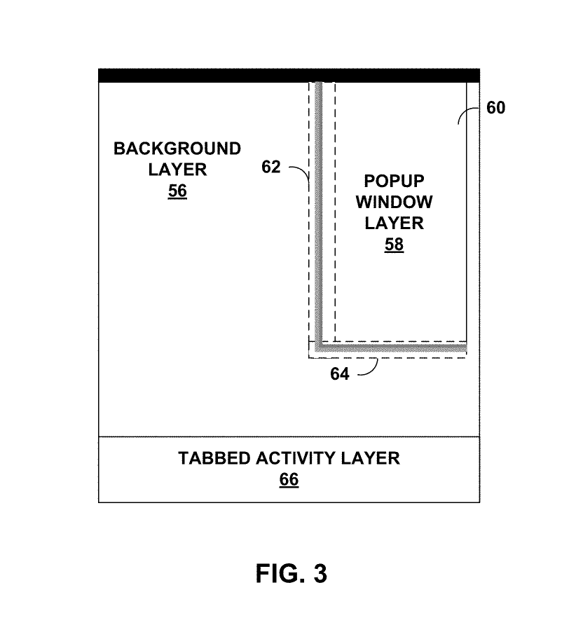

FIG. 3 is a graphical diagram of an image to illustrate an example operation in accordance with this disclosure. As illustrated in FIG. 3, for an image frame there may be three layers: background layer 56, popup window layer 58, and tabbed activity layer 66. There may be more example layers, but for ease of illustration, three layers are shown in FIG. 3.

In this example, the source coordinates for background layer 56 may be (0.0, 0.0, 1600.0, 2308.0), the frame coordinates for background layer 56 may be (0, 84, 1600, 2392), and the Z order value may be 0. The source coordinates for tabbed activity layer 66 may be (0.0, 0.0, 1600.0, 2392.0), the frame coordinates for tabbed activity layer 66 may be (0, 0, 1600, 2392), and the Z order value may be 1. The source coordinates for popup window layer 58 may be (0.0, 28.0, 1068.0, 1795.0), the frame coordinates for popup window layer 58 may be (532, 0, 1600, 1767), and the Z order value may be 2.

In FIG. 3, the size of popup window layer 58 is 1068×1767. However, the entirety of popup window layer 58 may not be opaque. Rather, in this example, some portion of popup window layer 58 may be opaque while another portion of popup window layer 58 is not opaque. As illustrated, popup window layer 58 includes inner rectangular portion 60, shadow border 62, and shadow border 64. Inner rectangular portion 60 may be substantially opaque, but shadow border 62, 64 may not be opaque. In this example, inner rectangular portion 60 may be approximately 902×1656 and occludes both the background layer 56 and tabbed activity layer 66. By avoiding the fetching of an area that covers an area of 902×1656 pixels, when retrieving image content for background layer 56 and tabbed activity layer 66, display processor 18 may retrieve approximately 12 mega-bytes (902*1656*4*2) fewer data, resulting in bandwidth savings of approximately 716 mega-bytes per second at 60 frames per second.

For example, in generating popup window layer 58, GPU 14 may generate opacity information for one or more blocks in popup window layer 58 (e.g., via opacity tracker circuit 40). As an example, opacity tracker circuit 40 may evaluate opacity for one or more pixels that GPU 14 outputs. For each of block of pixels, opacity tracker circuit 40 may determine whether all pixels in respective blocks are opaque or at least one pixel in respective blocks is not opaque. Opacity tracker circuit 40, via controller 34 or directly, stores a first value, in local memory 42, as opacity information for each block having all pixels that are opaque, and stores a second, different value, in local memory 42, as opacity information for each block of pixels having at least one pixel that is not opaque.

Host processor 12, via display compositor 30, may evaluate blocks in a diagonally inward direction starting from a top-left block of popup window layer 58 and a bottom-right block of popup window layer 58. In the example of FIG. 3, the top-left block of popup window layer 58 is located in shadow border 62 and the bottom-right block of popup window layer 58 is located in shadow border 64. Because shadow border 62 and shadow border 64 are both translucent, the opacity information for these blocks will indicate that there is at least one pixel that is not opaque. Host processor 12 may repeatedly evaluate the opacity information for blocks until host processor 12 reads opacity of a block within inner rectangular portion 60 starting from the top-left corner and a block within inner rectangular portion 60 starting from the bottom-right corner. These blocks may then define the source coordinates for inner rectangular portion 60. To confirm that inner rectangular portion 60 of popup window layer 58 is substantially opaque, host processor 12 may evaluate the opacity information of each of the blocks in popup window layer 58 to confirm that greater than 90% of the blocks are opaque.

After determining the source coordinates of inner rectangular portion 60, host processor 12 may determine the frame coordinates of inner rectangular portion 60 (e.g., by adding or subtracting the x, y coordinates based on the shift between the source coordinates and the frame coordinates of popup window layer 58). Host processor 12 may compare the frame coordinates of inner rectangular portion 60 to the frame coordinates of background layer 56 and tabbed activity layer 66. Based on the comparison, host processor 12 may determine frame coordinates for an area in background layer 56 that is occluded by inner rectangular portion 60, and frame coordinates for an area in tabbed activity layer 66 that is occluded by inner rectangular portion 60.

Host processor 12 may convert the frame coordinates for the area in background layer 56 to source coordinates for background layer 56 (e.g., by adding or subtracting the x, y coordinates based on the shift between the source coordinates and the frame coordinates of background layer 56). Similarly, host processor 12 may convert the frame coordinates for the area in tabbed activity layer 66 to source coordinates for tabbed activity layer 66 (e.g., by adding or subtracting the x, y coordinates based on the shift between the source coordinates and the frame coordinates of tabbed activity layer 66). For the occlusion register of background layer 56, host processor 12 may store the source coordinates for the area of background layer 56 occluded by inner rectangular portion 60, and for the occlusion register of tabbed activity layer 66, host processor 12 may store the source coordinates for the area of tabbed activity layer 66 occluded by inner rectangular portion 60.

Display processor 18 may retrieve image content of background layer 56, popup window layer 58, and tabbed activity layer 66 via respective pipes 50. However, display processor may not retrieve the area defined in the occlusion register for background layer 56, and not retrieve the area defined in the occlusion register for tabbed activity layer 66. Blender circuit 46 may blend the retrieved image content to compose the example image frame illustrated in FIG. 3.

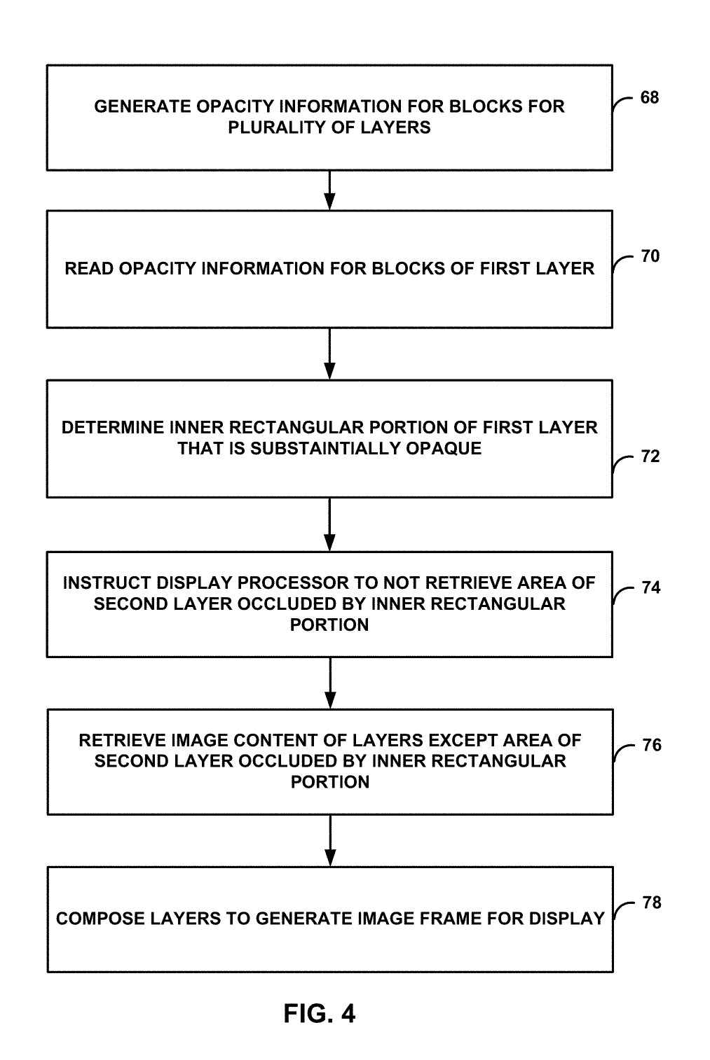

FIG. 4 is a flowchart illustrating an example technique in accordance with this disclosure. Processing circuitry, such as GPU 14, may generate opacity information for blocks for a plurality of layers (68). For instance, as part of writing out the layers to layer buffers 52, opacity tracker circuit 40 may generate opacity information for the layers. Opacity tracker circuit 40, via controller 34 or directly, may store, in local memory 42, a first value for a block of a layer that is opaque, and a second, different value for a block of the layer that is not opaque. GPU driver 28 may store this opacity information for each layer in corresponding ones of meta buffers 54, where each one of meta buffers 54 is associated with one of layer buffers 52.

Host processor 12, via execution of display compositor 30, may read opacity information for blocks of a first layer (70). For example, display compositor 30 may read opacity information stored in meta buffer 54A for a first layer stored in layer buffer 52A. Host processor 12, via execution of display compositor 30, may determine inner rectangular portion of the first layer that is substantially opaque (72). As an example, host processor 12 may start from diagonally opposite blocks of the first layer, and evaluate blocks in a diagonally inward direction until host processor 12 identifies two blocks that are opaque. The coordinates of the two blocks that are opaque may define the source coordinates for the inner rectangular portion of the first layer.

Host processor 12 may instruct display processor 18 to not retrieve, for use in composing the plurality of layers, an area of a second layer that is occluded by the inner rectangular portion of the first layer (74). As an example, host processor 12 may determine the frame coordinates of the inner rectangular portion of the first layer based on the screen coordinates, determine the frame coordinates of the second layer, determine frame coordinates of an area of the second layer that is occluded by the inner rectangular portion of the first layer, the inner rectangular portion being smaller than the first layer, determine screen coordinates of the area of the second layer that is occluded by the inner rectangular portion, and store these screen coordinates in the occlusion registers for the second layer.

Accordingly, in some examples, to perform the example operations illustrated in FIG. 4, host processor 12 may execute display compositor 30. In such examples, reading the opacity information, determining the inner rectangular portion, and instructing display processor 18 may include reading the opacity information, determining the inner rectangular portion, and instructing display processor 18 with the host processor 12 due to the execution of display compositor 30.

Display processor 18 may retrieve image content of the first and second layers from respective pipes 50, except the area of the second layer that is occluded by the inner rectangular portion of the first layer (76). Display processor 18 may compose the layers to generate an image frame for display (78). For instance, display processor 18 may blend the retrieved image content from the first and second layers to generate the image frame for display. Display 19 may be configured to display the image frame.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for generating image content for display, the device comprising:
a display processor configured to compose a plurality of layers of image content to generate an image frame for display;
processing circuitry configured to generate opacity information for one or more blocks of pixels of a first layer of the plurality of layers, wherein the opacity information indicates whether all pixels in a block are opaque or at least one pixel in the block is not opaque;
a host processor configured to:
read the opacity information for one or more blocks of pixels of the first layer;
determine an inner rectangular portion of the first layer that is substantially opaque based on the read opacity information; and
instruct the display processor to not retrieve, for use in composing the plurality of layers, an area of a second layer of the plurality of layers that is occluded by the inner rectangular portion of the first layer.

2. The device of claim 1, wherein the host processor is configured to execute a display compositor, wherein execution of the display compositor causes the host processor to:
read the opacity information for one or more blocks of pixels of the first layer;
determine the inner rectangular portion that is substantially opaque based on the read opacity information; and
instruct the display processor to not retrieve, for use in composing the plurality of layers, the area of the one or more layers that is occluded by the inner rectangular portion of the first layer.

3. The device of claim 1, wherein, to determine the inner rectangular portion, the host processor is configured to:
evaluate, in a diagonally inwards direction, the opacity information starting from a first block and a second block of the first layer;
identify a third block after the first block, wherein opacity information for the third block indicates that all pixels in the third block are opaque;
identify a fourth block after the second block, wherein opacity information for the fourth block indicates that all pixels in the fourth block are opaque; and
determine the inner rectangular portion based on locations of the third block and the fourth block.

4. The device of claim 3, wherein the first block comprises a top-left block of the first layer, and the second block comprises a bottom-right block of the first layer, and wherein to determine the inner rectangular portion, the host processor is configured to determine the inner rectangular portion based on the third block being in a top-left corner of the inner rectangular portion and the fourth block being in a bottom-right corner of the inner rectangular portion.

5. The device of claim 3, wherein the host processor is configured to:
evaluate opacity information in each block in the inner rectangular portion; and
confirm that the inner rectangular portion is opaque based on opacity information for each block in the inner rectangular portion indicating that all pixels in each block in the inner rectangular portion are opaque.

6. The device of claim 1, wherein the host processor is configured to:
determine coordinates of the area in the second layer based on the inner rectangular portion of the first layer; and
wherein to instruct the display processor to not retrieve, for use in composing the plurality of layers, the area of the second layer, the host processor is configured to instruct the display processor to not retrieve, for use in composing the plurality of layers, the area of the second layer that is covered by the inner rectangular portion based on the determined coordinates of the area.

7. The device of claim 1, wherein the processing circuitry is configured to:
evaluate opacity for one or more pixels that the processing circuitry outputs;
for each of the blocks of the pixels, determine whether all pixels in respective blocks are opaque or at least one pixel in the respective blocks is not opaque;
store a first value as opacity information for each of the blocks of pixels having all pixels that are opaque; and
store a second, different value as opacity information for each of the blocks of pixels having at least one pixel that is not opaque.

8. The device of claim 1, wherein, to compose the plurality of layers, the display processor is configured to:
retrieve image content of the first layer;
retrieve image content of the second layer except for the area of the second layer that is occluded by the inner rectangular portion of the first layer; and
blend the retrieved image content of the first layer and the retrieved image content of the second layer.

9. The device of claim 1, further comprising a display configured to display the image frame.

10. A method for generating image content for display, the method comprising:
generating, with processing circuitry, opacity information for one or more blocks of pixels of a first layer of the plurality of layers, wherein the opacity information indicates whether all pixels in a block are opaque or at least one pixel in the block is not opaque;
reading, with a host processor, the opacity information blocks of a first layer of a plurality of layers of image content;
determining, with the host processor, an inner rectangular portion of the first layer that is substantially opaque based on the read opacity information;
instructing, with the host processor, a display processor to not retrieve, for use in composing the plurality of layers, an area of a second layer of the plurality of layers that is occluded by the inner rectangular portion of the first layer; and
composing, with the display processor, the plurality of layers to generate an image frame for display.

11. The method of claim 10, further comprising:
executing, with the host processor, a display compositor,
wherein reading the opacity information, determining the inner rectangular portion, and instructing the display processor comprises reading the opacity information, determining the inner rectangular portion, and instructing the display processor with the host processor due to the execution of the display compositor.

12. The method of claim 10, wherein determining the inner rectangular portion comprises:
evaluating, in a diagonally inwards direction, the opacity information starting from a first block and a second block of the first layer;
identifying a third block after the first block, wherein opacity information for the third block indicates that all pixels in the third block are opaque;
identifying a fourth block after the second block, wherein opacity information for the fourth block indicates that all pixels in the fourth block are opaque; and
determining the inner rectangular portion based on locations of the third block and the fourth block.

13. The method of claim 12, wherein the first block comprises a top-left block of the first layer, and the second block comprises a bottom-right block of the first layer, and wherein determining the inner rectangular portion comprises determining the inner rectangular portion based on the third block being in a top-left corner of the inner rectangular portion and the fourth block being in a bottom-right corner of the inner rectangular portion.

14. The method of claim 12, further comprising:
evaluating opacity information in each block in the inner rectangular portion; and
confirming that the inner rectangular portion is opaque based on opacity information for each block in the inner rectangular portion indicating that all pixels in each block in the inner rectangular portion are opaque.

15. The method of claim 10, further comprising:
determining coordinates of the area in the second layer based on the inner rectangular portion of the first layer; and
wherein instructing the display processor to not retrieve, for use in composing the plurality of layers, the area of the second layer comprises instructing the display processor to not retrieve, for use in composing the plurality of layers, the area of the second layer that is covered by the inner rectangular portion based on the determined coordinates of the area.

16. The method of claim 10, wherein generating the opacity information comprises:
evaluating opacity for one or more pixels that the processing circuitry outputs;
for each of the blocks of the pixels, determining whether all pixels in respective blocks are opaque or at least one pixel in the respective blocks is not opaque;
storing a first value as opacity information for each of the blocks of pixels having all pixels that are opaque; and
storing a second, different value as opacity information for each of the blocks of pixels having at least one pixel that is not opaque.

17. The method of claim 10, wherein composing the plurality of layers comprises:
retrieving image content of the first layer;
retrieving image content of the second layer except for the area of the second layer that is occluded by the inner rectangular portion of the first layer; and
blending the retrieved image content of the first layer and the retrieved image content of the second layer.

18. The method of claim 10, further comprising:
displaying the image frame.

19. A device for generating image content for display, the device comprising:
means for generating opacity information for one or more blocks of pixels of a first layer of the plurality of layers, wherein the opacity information indicates whether all pixels in a block are opaque or at least one pixel in the block is not opaque;
means for reading the opacity information for blocks of a first layer of a plurality of layers of image content;
means for determining an inner rectangular portion of the first layer that is substantially opaque based on the read opacity information;
means for instructing a display processor to not retrieve, for use in composing the plurality of layers, an area of a second layer of the plurality of layers that is occluded by the inner rectangular portion of the first layer; and
means for composing the plurality of layers to generate an image frame for display.

20. The device of claim 19, wherein the means for determining the inner rectangular portion comprises:
means for evaluating, in a diagonally inwards direction, the opacity information starting from a first block and a second block of the first layer;
means for identifying a third block after the first block, wherein opacity information for the third block indicates that all pixels in the third block are opaque;
means for identifying a fourth block after the second block, wherein opacity information for the fourth block indicates that all pixels in the fourth block are opaque; and
means for determining the inner rectangular portion based on locations of the third block and the fourth block.
